(19) United States
(12) Patent Application Publication
(10) Pub. No.: US 2023/0001612 A1
(43) Pub. Date: Jan. 5, 2023

(54) A MOLD TOOL FOR INJECTION MOLDING (as amended hereby)

(71) Applicant: LEGO A/S, Billund (DK)

(72) Inventor: Jens Stamp LAMBÆK, Billund (DK)

(21) Appl. No.: 17/781,953

(22) PCT Filed: Dec. 2, 2020
(86) PCT No.: PCT/EP2020/084224

§ 371 Date: Jun. 2, 2022

(30) Foreign Application Priority Data
Dec. 3, 2019 (DK) PA201970745

(51) Int. Cl. B29C 45/27; B29C 45/30

(52) U.S. Cl. CPC B29C 45/2704; B29C 45/2756; B29C 45/30

(57) ABSTRACT

An injection molding tool configured for being mounted in an injection molding apparatus for automated molding of work pieces in plastics, said injection molding tool comprising at least one main runner channel extending between the sprue channel and a runner branch where it branches into two or more branched runner channels leading to the mold cavities, and where at least the main runner channel downstream from the sprue channel comprises two flow channels being mutually joined at a runner junction downstream from the sprue channel, and wherein the two flow channels until the runner junction are linear and extending parallel to each other, and being completely or partly separated by a linear separating wall.

### RELATED APPLICATIONS

The present application claims the benefit of and priority to DK Patent Application No. PA201970608 dated Sep. 30, 2019, and is a U.S. national stage application under 35 U.S.C. 371 of co-pending International Application No. PCT/EP2020/076257 filed on Sep. 21, 2020, the contents of each are incorporated by reference herein in their entirety for all purposes.

### BACKGROUND OF THE INVENTION

### 1. Field of Invention

The present disclosure relates to an injection-molding tool configured for being mounted in an injection-molding apparatus for automated molding of work pieces in plastics. The injection-molding tool comprising at least two separate mold parts forming a set of mold cavities, and the separate mold parts include an inlet mold part having a mold inlet for injection of liquid plastics from the injection-molding apparatus, and a second mold part, and where the mold parts have abutting side faces facing a common mold separation plane, and where the abutting side faces form a set of runner channels extending between the mold inlet and the mold cavities, and where the runner channels comprise two flow channels being mutually joined at a junction at the downstream end of the two flow channels.

### 2. Background of Related Art

Advances in the art usually precede changes in fields and disciplines that are ancillary to the art. One example of this phenomenon is in the area of injection molding. US Published Patent Application 2004/0047943 discloses an injection-molding tool for a quick and efficient uniform heating of a compound prior to entering a mold cavity. Here, the spaced flow channels are arranged at intersecting angles to each other to create cross sectional flow, and thereby an increased mixing of the material flowing in the intersecting flow channels. This structure uniformly increases the temperature of the injected compound as the compound flows from the injection port to the various drop gates.

Accordingly, there is a need in the relevant art for a molding tool with cold runners, capable of quickly moving molten material to all mold cavities without increasing injection pressure and temperature.

### SUMMARY OF THE INVENTION

The present disclosure is directed to an injection-molding tool with cold runners, where the cold runner channels or injection runner channels allow to quickly convey molten material to all mold cavities, but without unnecessary increase of the injection pressure and the temperature of the molten material, or without unnecessarily long cooling times for cooling the material in the injection runner before demolding.

This is accomplished by the use of two flow channels that are linear and extend parallel to each other until a junction, and are completely or partly separated by a linear separating wall.

According to an embodiment of the molding tool, the molding tool further comprises a closing mold part, and wherein the second mold part is arranged between the inlet mold part and the closing mold part, and where the closing mold part and the second mold part has second abutting side faces facing a second common mold separation plane, and where the second abutting side faces forms the mold cavities.

The two flow channels may have a cross section that is circular, semi-circular, elliptical, semi-elliptical, polygonal, or any other cross section in a direction perpendicular to the flow direction in the flow channels allowing the molten material to be conveyed efficiently through the flow channels.

Advantageously the two parallel flow channels, and optionally the separating wall, extends from the mold inlet and all the way to the runner branch.

Furthermore, it is advantageous if the separating wall is configured such that the two flow channels are open to each other at the side of the flow channels being closest to each other. Thereby the demolded distributor part is more stiff, and easier to demold.

It should be appreciated that the subject disclosure can be implemented and utilized in numerous ways, including without limitation as a process, an apparatus, a system, a device, and a method for applications now known and later developed. These and other unique features of the apparatus disclosed herein will become more readily apparent from the following description and the accompanying drawings.

### BRIEF DESCRIPTION OF THE DRAWINGS

So that those having ordinary skill in the art to which the disclosed apparatus appertains will more readily understand how to make and use the same, reference may be had to the following drawings

FIG. 1 is a perspective view of a distributor or runner channel in an injection mold in accordance with the subject disclosure.

FIG. 2-4 illustrate various embodiments of the cross section of the main runner channel shown in FIG. 1.

### DETAILED DESCRIPTION

The subject technology overcomes many of the prior art problems associated with injection-molding tools.

The advantages, and other features of the apparatus disclosed herein, will become more readily apparent to those having ordinary skill in the art from the following detailed description of certain preferred embodiments taken in conjunction with the drawings, which set forth representative embodiments of the present invention and wherein like reference numerals identify similar structural elements. It is understood that references to the figures such as up, down, upward, downward, left, and right are with respect to the figures and not meant in a limiting sense.

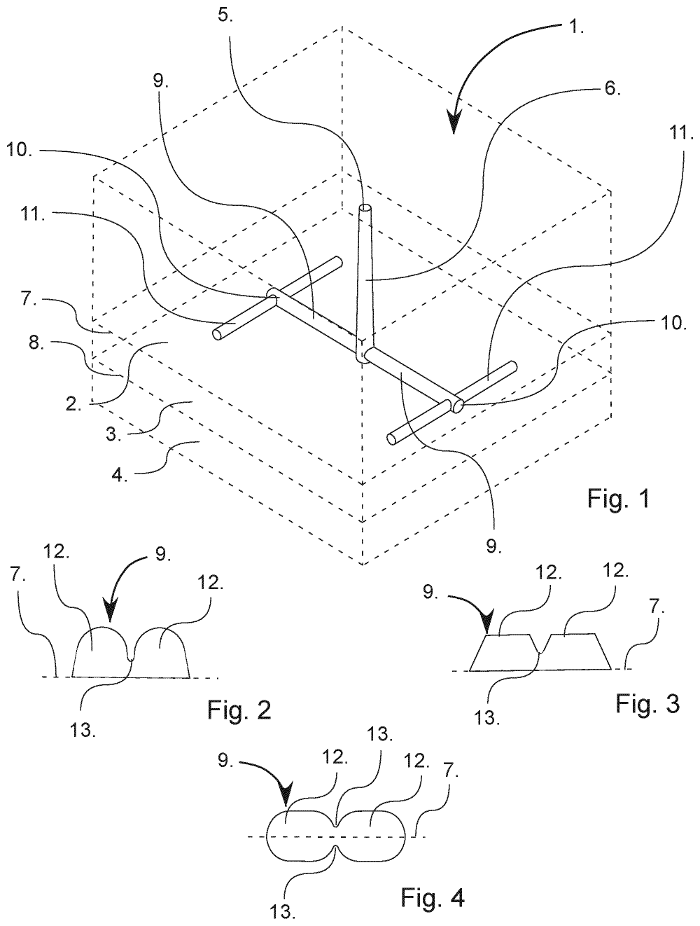

FIG. 1 is a principle drawing showing the principle construction of an injection molding tool 1 having three separate mold parts 2, 3, 4 comprising an inlet mold part 2, an intermediate/second mold part 3 and a closing mold part 4.

The inlet mold part 2 has a sprue channel 6 extending between a mold inlet 5 and a set of main runner channels 11 each extending from the sprue channel 6 and being connected downstream via runner branches 10 into a set of branched runner channels 11 that are again leading to multiple mould cavities (not shown) directly or via a number of further runner branches and branched runner channels (not shown).

In this embodiment the injection-molding tool 1 comprises three mold parts as mentioned above, and the inlet mold part 2 and the intermediate/second mold part 3 has abutting side faces forming a mold separation plane 7 where the runner channels (cold runners) are formed. The intermediate mold part 3 and the closing mold part 4 likewise have abutting side faces forming a second mold separation plane 8, where the mold cavities (not shown) form the molded product. It is however obvious to the skilled person that the present disclosure may also be used in connection with an injection-molding tool having only two separate mold parts, namely the inlet mold part 2, and the second mold part 3. In this embodiment the mold cavities (not shown) are arranged in the same mold separation plane 7 as the runner channels 9, 11 (cold runners).

In order to ensure efficient distribution of molten plastic to the mold cavities, the main runner channels 9, as shown in FIG. 1, have a cross section being larger than the cross section of the branched runner channels 11.

FIGS. 2, 3 and 4 illustrate different embodiments of cross sections of the main runner channels perpendicular to the flow direction of the molten plastic in the main runner channels 9 shown in FIG. 1. Each embodiment has two linear flow channels 12 separated by a linear separating wall 13, such that the molten plastic material flowing through the main runner channels 9 is divided into mainly two separate streams.

In the embodiments shown in FIGS. 2, 3 and 4 the linear separating wall 13 does not completely separate the two flow channels 12, and therefore the runner formed by the main runner channels 9 is more stable so that demolding of the runner from the main runner channels 9 is more reliable. It is however obvious to the skilled person that the straight separating walls may also extend all the way across the cross section of the main runner channels 9 so that the flow channels 12, and therefore the runner formed by the main runner channels 9 is completely separated.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

All patents, patent applications and other references disclosed herein are hereby expressly incorporated in their entireties by reference.

While the subject technology has been described with respect to preferred embodiments, those skilled in the art will readily appreciate that various changes and/or modifications can be made to the subject technology without departing from the spirit or scope of the invention as defined by the appended claims.

1. An injection molding tool configured to be mounted in an injection molding apparatus for automated molding of work pieces in plastics comprising,
at least two separate mold parts forming a set of mold cavities having abutting side faces on a common mold separation plane forming at least one main runner channel extending between a sprue channel and a runner branch, the main runner channel configured to branch into two or more branched runner channels leading to the mold cavities and comprising two linear and parallel flow channels mutually joined at a runner junction downstream from the sprue channel and at least partly separated by a linear separating wall, the at least two separate mold parts comprising,
an inlet mold part comprising a mold inlet and the sprue channel for injection of liquid plastics from the injection molding apparatus; and
a second mould mold part.

2. An injection molding tool according to claim 1, and further comprising a closing mold part, and wherein the second mold part is arranged between the inlet mold part and the closing mold part, and wherein the closing mold part and the second mold part have second abutting side faces facing a second common mold separation plane, and where the second abutting side faces form the mold cavities.

3. An injection molding tool according to claim 1, wherein both the two linear and parallel flow channels have a cross section, and the cross section is at least partly circular, semi-circular, semi-elliptical, semi-elliptical, or polygonal in a direction perpendicular to the flow direction in the two flow channels.

4. An injection molding tool according to claim 3, wherein the two linear and parallel flow channels extend from the sprue channel, and the runner junction is formed by the runner branch.

5. An injection molding tool according to claim 3, wherein the separating wall is configured such that the two linear and parallel flow channels are open to each other at the side of the linear and parallel flow channels closest to each other.

6. An injection molding tool according to claim 1, wherein the two or more branched runner channels form a cold runner.

7. An injection-molding tool according to claim 1, wherein the mold cavities are arranged in the same mold separation plane as the two or more branched runner channels.

8. An injection-molding tool according to claim 2, wherein the at least one main runner channel has a cross-section larger than a cross-section of each of the two or more branched runner channels.

9. An injection-molding tool for efficient distribution of molten plastic to mold cavities comprising:
a sprue channel defining an inlet in communication with a source of the molten plastic;
a main runner channel coupled to the sprue channel that substantially divides the molten plastic into two separate streams; and
at least two branched runner channels coupled to the main runner channel and defining an outlet in communication with the mold cavities, each of the at least two branched runner channels substantially receiving one of the two separate streams.

10. An injection-molding tool according to claim 9, further comprising a first mold part, a second mold part, and a closing mold part, wherein the second mold part is arranged between the inlet and the closing mold part, and wherein the inlet mold part and the second mold part have first abutting side faces facing a first common mold separation plane, and the closing mold part and the second mold part have second abutting side faces facing a second common mold separation plane.

11. An injection-molding tool according to claim 9, wherein a cross-section of the main runner channel is larger than a cross-section of each of the at least two branched channels.

12. An injection-molding tool according to claim 9, further comprising two linear and parallel flow channels extending from the sprue channel.

13. An injection-molding tool according to claim 12, further comprising a separating wall between the two linear and parallel flow channels, and wherein the two linear and parallel flow channels are open to each other at a side of the linear and parallel flow channels closest to each other.

14. An injection-molding tool according to claim 9, wherein the at least two branched runner channels form a cold runner.

15. An injection-molding tool configured to be mounted in an injection-molding apparatus for automated molding of work pieces in plastics comprising,
at least three separate mold parts forming a set of mold cavities forming at least one main runner channel configured to branch into two or more branched runner channels and comprising two flow channels mutually joined at a runner junction, the at least three separate mold parts comprising,
an inlet mold part;
a closing mold part; and
a second mold part.

16. An injection-moulding tool according to claim 15, wherein the inlet mold part and the second mold part have first abutting side faces facing a first common mold separation plane, and the closing mold part and the second mold part have second abutting side faces facing a second common mold separation plane.

17. An injection-moulding tool according to claim 16, wherein the first and second abutting side faces form mold cavities.

18. An injection-moulding tool according to claim 15, wherein the inlet mold has a mold inlet and a sprue channel for injection of liquid plastics from the injection-molding apparatus.

19. An injection-moulding tool according to claim 15, wherein the second mold part is positioned between the inlet mold part and the closing mold part.

20. An injection-molding tool according to claim 15, wherein the two flow channels are linear and parallel, and have a cross section at least partly circular, semi-circular, semi-elliptical, semi-elliptical, or polygonal in a direction perpendicular to the flow direction in the two flow channels.
